(19) United States
(12) Patent Application Publication
(10) Pub. No.: US 2008/0284894 A1
(43) Pub. Date: Nov. 20, 2008

(54) DEVICE CAPABLE OF IMAGE CAPTURING AND IMAGE PROJECTION

(76) Inventor: Keng-Kuei Su, Kaohsiung City (TW)

Correspondence Address: HAMMER & ASSOCIATES, P.C., 3125 SPRINGBANK LANE, SUITE G, CHARLOTTE, NC, 28226, US

(21) Appl. No.: 11/923,893

(22) Filed: Oct. 25, 2007

(30) Foreign Application Priority Data
May 16, 2007 (CN) 200710074391.1

(51) Int. Cl. H04N 5/222; H04N 9/31; H04N 5/64

(52) U.S. Cl. 348/333.1; 348/744

(57) ABSTRACT

A device capable of image capturing and image projection includes a housing, an image capturing module, an image projecting module, and a control unit. The image capturing module is mounted to the housing and is operable to capture an image. The image projecting module is mounted to the housing and is operable to project the image captured by the image capturing module. The control unit is mounted in the housing, is coupled to the image capturing module and the image projecting module, and is operable to control operations of the image capturing module and the image projecting module.

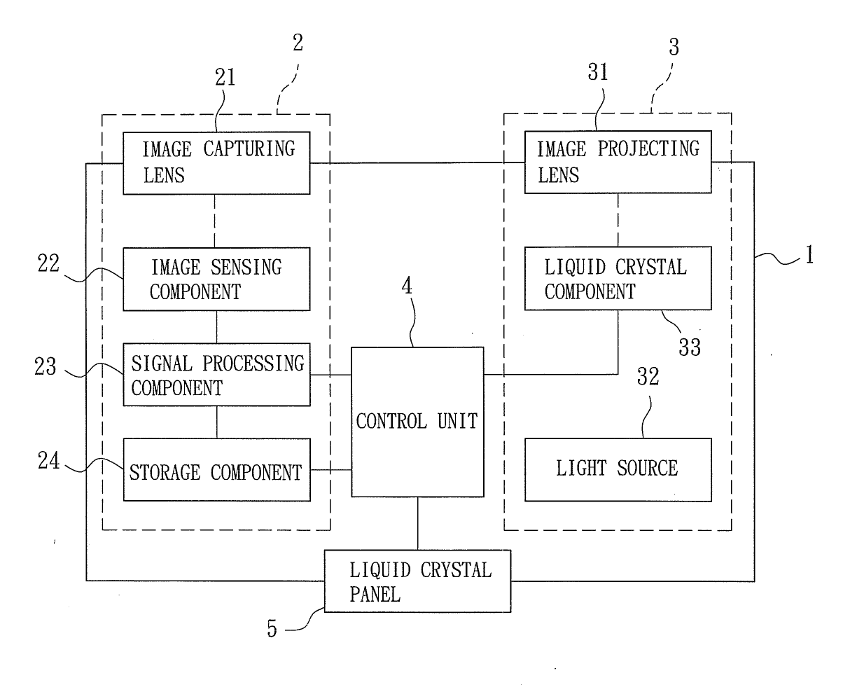

### CROSS-REFERENCE TO RELATED APPLICATION

This application claims priority of Chinese application no. 200710074391.1, filed on May 16, 2007.

### BACKGROUND OF THE INVENTION

1. Field of the Invention

The invention relates to an optical device, more particularly to a device capable of image capturing and image projection.

2. Description of the Related Art

A digital camera utilizes an image sensing component to sense a captured image for subsequent storage in a storage component, and thereafter utilizes a liquid crystal screen mounted to the camera body for image display. However, due to size limitations of the liquid crystal screen, the displayed image is best suited for viewing by a single user, i.e., it is inconvenient for multiple users to view the displayed image at the same time.

On the other hand, an image projector is utilized so that multiple users are able to view projected images in an enlarged form at the same time. While image projectors are often found in offices and educational institutions for making presentations, they are now gaining popularity as a household appliance in view of a steep reduction in the price thereof and greater consumer interest in home theater applications. Nonetheless, portability of the conventional image projector is not satisfactory such that use thereof is often limited to a particular spot in a premise.

### SUMMARY OF THE INVENTION

Therefore, the object of the present invention is to provide a device capable of image capturing and image projection, which has the advantages of digital cameras and image projectors.

Accordingly, a device capable of image capturing and image projection of the present invention comprises a housing, an image capturing module, an image projecting module, and a control unit. The image capturing module is mounted to the housing and is operable to capture an image. The image projecting module is mounted to the housing and is operable to project the image captured by the image capturing module. The control unit is mounted in the housing, is coupled to the image capturing module and the image projecting module, and is operable to control operations of the image capturing module and the image projecting module.

### BRIEF DESCRIPTION OF THE DRAWING

Other features and advantages of the present invention will become apparent in the following detailed description of the preferred embodiment with reference to the accompanying drawing, of which:

The FIGURE is a schematic block diagram of the preferred embodiment of a device capable of image capturing and image projection according to the present invention.

### DETAILED DESCRIPTION OF THE PREFERRED EMBODIMENT

Referring to the FIGURE, the preferred embodiment of a device capable of image capturing and image projection according to the present invention is shown to comprise a housing 1, an image capturing module 2, an image projecting module 3, a control unit 4, and a liquid crystal panel 5.

The image capturing module 2 is mounted to the housing 1, is operable to capture an image, and includes an image capturing lens 21 mounted on the housing 1, an image sensing component 22 associated operably with the image capturing lens 21 for generating an electrical output that corresponds to an image received thereby via the image capturing lens 21, a signal processing component 23 coupled to the image sensing component 22 for processing the electrical output of the image sensing component 22 into image data, and a storage component 24 coupled to the signal processing unit 23 for storing the image data.

The image projecting module 3 is mounted to the housing 1, is operable to project the image captured by the image capturing module 2, and includes an image projecting lens 31 mounted on the housing 1, a light source 32 mounted in the housing 1, and a liquid crystal component 33 mounted in the housing 1, disposed between the image projecting lens 31 and the light source 32, and coupled to and controlled by the control unit 4 for processing light from the light source 32 to result in the image that is to be projected via the image projecting lens 31.

The control unit 4 is mounted in the housing 1, is coupled to the image capturing module 2 and the image projecting module 3, and is operable to control operations of the image capturing module 2 and the image projecting module 3. In the preferred embodiment, the control unit 4 is coupled to the storage component 24 and the signal processing component 23 of the image capturing module 2 and the liquid crystal component 33 of the image projecting module 3, and controls the liquid crystal component 33 according to the image data stored in the storage component 24.

The liquid crystal panel 5 is mounted on the housing 1, is coupled to the control unit 4, and is operable so as to display the image captured by the image capturing module 2 and stored in the storage component 24.

In use, by operating the control unit 4 in an image capturing mode, images can be captured through the image capturing module 2 and stored in the storage component 24. Thereafter, captured images in the storage component 24 may be viewed through the liquid crystal panel 5 by operating the control unit 4 in an image playback mode, or through the image projecting module 3 by operating the control unit 4 in an image projecting mode.

In sum, this invention combines image capturing and image projecting functions in a single device. Aside from permitting captured images to be viewed on the liquid crystal panel 5, the device also permits projection of captured images for viewing by multiple users at the same time. The size of the device of this invention is further designed for enhanced portability so that use of the same is not limited to a particular spot in a premise.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A device capable of image capturing and image projection, comprising:
a housing;
an image capturing module mounted to said housing and operable to capture an image;
an image projecting module mounted to said housing and operable to project the image captured by said image capturing module; and
a control unit mounted in said housing, coupled to said image capturing module and said image projecting module, and operable to control operations of said image capturing module and said image projecting module.

2. The device as claimed in claim 1, wherein said image capturing module includes
an image capturing lens mounted on said housing,
an image sensing component associated operably with said image capturing lens for generating an electrical output that corresponds to an image received thereby via said image capturing lens,
a signal processing component coupled to said image sensing component for processing the electrical output of said image sensing component into image data, and
a storage component coupled to said signal processing unit for storing the image data.

3. The device as claimed in claim 2, wherein said image projecting module includes
an image projecting lens mounted on said housing,
a light source mounted in said housing, and
a liquid crystal component mounted in said housing, disposed between said image projecting lens and said light source, and coupled to and controlled by said control unit for processing light from said light source to result in the image that is to be projected via said image projecting lens.

4. The device as claimed in claim 3, wherein said control unit is coupled to said storage component, said signal processing component and said liquid crystal component, and controls said liquid crystal component according to the image data stored in said storage component.

5. The device as claimed in claim 4, further comprising a liquid crystal panel mounted on said housing, coupled to said control unit, and operable so as to display the image captured by said image capturing module and stored in said storage component.

6. The device as claimed in claim 2, further comprising a liquid crystal panel mounted on said housing, coupled to said control unit, and operable so as to display the image captured by said image capturing module and stored in said storage component.

7. The device as claimed in claim 1, wherein said image projecting module includes
an image projecting lens mounted on said housing,
a light source mounted in said housing, and
a liquid crystal component mounted in said housing, disposed between said image projecting lens and said light source, and coupled to and controlled by said control unit for processing light from said light source to result in the image that is to be projected via said image projecting lens.
